(19) United States
(12) Patent Application Publication
(10) Pub. No.: US 2026/0012129 A1
(43) Pub. Date: Jan. 8, 2026

(54) FOUNDATION STRUCTURE FOR SOLAR PANEL

(71) Applicant: APA SOLAR, LLC, Ridgeville Corners, OH (US)

(72) Inventors: Joseph Von Deylen, Whitehouse, OH (US); Josh Von Deylen, Bryan, OH (US); Shawn Jeremy Ramey, Ney, OH (US); Richard Alan Roth, Archbold, OH (US); Erik Steven Shinabery, Bryan, OH (US)

(21) Appl. No.: 19/262,398

(22) Filed: Jul. 8, 2025

Related U.S. Application Data
(60) Provisional application No. 63/668,365, filed on Jul. 8, 2024.

(51) Int. Cl. H02S 20/32

(52) U.S. Cl. CPC H02S 20/32

(57) ABSTRACT

A foundation structure for supporting a solar panel installation is provided. The foundation structure includes a frame defined by a first tube coupled to a second tube, each tube having a horizontal portion and a vertical portion, and a connecting tube extending within the horizontal portions to couple the first tube to the second tube. A substantially rectangular mounting bracket is secured to the first and second tubes with a plurality of fasteners and is configured to attach to a solar panel. The mounting bracket includes a top wall, a first end wall having a pair of outwardly extending protuberances that define a hemispherical opening to receive the first tube, and a second end wall having a pair of outwardly extending protuberances that define a hemispherical opening to receive the second tube. A solar panel system and a method of installing the solar panel system is also provided.

### CROSS-REFERENCE TO RELATED APPLICATIONS

This application claims the benefit of U.S. Provisional Application Ser. No. 63/668,365, filed on Jul. 8, 2024. The entire disclosure of the above application is incorporated herein by reference.

### FIELD

The present technology relates to structural foundations for solar panel installations, and more particularly, to improvements in the foundational support structure of solar trackers.

### Introduction

This section provides background information related to the present disclosure which is not necessarily prior art.

Solar panel installation presents challenges in environments with adverse terrain conditions, including loose or frozen soil, uneven topography, and unstable ground conditions. Certain solar panel foundation systems, which may rely on a single driven pile for structural support, must achieve substantial embedment depth and depend primarily on skin friction to withstand environmental loads. While an A-frame solar panel foundation offers improved economic viability for challenging installation sites, certain configurations of A-frame solar panel foundations may suffer from inherent rigidity that militates against post-installation adjustments. The A-frame solar panel foundation may also be configured in multiple separate pieces that require coupling together in a desired location. This inflexibility creates difficulties when terrain conditions change or when initial installation calculations require correction, often necessitating extensive remedial work that increases project costs and extends construction timelines, particularly in retrofit applications or solar farm expansions. Complexity with coupling each of the separate components together may also be time-consuming and may result in complications post-installation if the installation has to account for miscalculations or installation errors.

Certain solar panel foundation systems may also present multiple configuration limitations and operational deficiencies that impact installation efficiency and system performance. This is because some foundation configurations require additional mounting brackets to secure the solar panel frame to the foundation structure, increasing component complexity, reducing system reliability, and elevating manufacturing and installation costs. Foundation components may also feature oversized or irregularly shaped elements that create significant logistical challenges during transportation and handling. These limitations result in inefficient packaging configurations, increased shipping costs, and transportation capacity complexity and inefficiency. The assembly process for certain foundation systems may also require extensive manual labor and complex multi-component installation procedures that are particularly challenging under adverse field conditions. This may lead to extended project schedules and increased risk of installation errors that can compromise system integrity and performance.

Accordingly, there is a need for an integrated solar tracker foundation system that simplifies installation procedures, reduces component complexity, enhances transportation efficiency through consolidated elements and the reduction of components, and improves overall cost-effectiveness and system reliability by enabling post-installation adjustments to accommodate varying site conditions.

### SUMMARY

In concordance with the instant disclosure, an integrated solar tracker foundation system that simplifies installation procedures, reduces component complexity, enhances transportation efficiency through consolidated elements and the reduction of components, and improves overall cost-effectiveness and system reliability by enabling post-installation adjustments to accommodate varying site conditions, has surprisingly been discovered. The present technology includes articles of manufacture, systems, and processes that relate to solar tracker foundation systems utilizing A-frames for solar panel installations.

In certain embodiments, a foundation structure for supporting a solar panel may include a frame, a connecting tube, and a mounting bracket. The frame may be defined by a first tube configured to be coupled to a second tube where each of the first tube and the second tube may include a horizontal portion and a vertical portion. The connecting tube may be configured to be received within each of the horizontal portion of the first tube and the horizontal portion of the second tube for coupling the tubes together. The mounting bracket may be configured to be secured to the first tube and the second tube with a plurality of fasteners. The plurality of fasteners may include screws, nuts, bolts, and U-shaped bolt fasteners. The mounting bracket may be configured to be coupled to a solar panel via the fasteners. The mounting bracket may also have a substantially rectangular shape including a top wall, a first end wall, and a second end wall. The first end wall may have a first pair of protuberances extending outwardly where each of the protuberances may define a hemispherical opening for receiving the first tube of the frame. The second end wall may have a second pair of protuberances extending outwardly where each of the protuberances may define a hemispherical opening for receiving the second tube of the frame. Advantageously, the foundation structure provides an enhanced support structure for a solar panel installation militating against the need for multiple separate components and allows the frame to pivot relative to the mounting bracket for slip adjustment.

In certain embodiments, a solar panel system may include the foundation structure as described herein. The solar panel may also include a ground screw configured to be attached to the vertical portion of the frame and may be secured in a ground surface to provide anchoring of the solar panel installation. The solar panel system may further include a solar panel configured to be coupled to the foundation structure. The solar panel may include a base and may be configured to be attached to the mounting bracket of the foundation structure.

In certain embodiments, a method of installing a solar panel include a step of providing a solar panel system as described herein. The method may include steps of coupling the first tube to the second tube using the connecting tube, coupling the mounting bracket to the frame, and disposing the ground screw into the ground surface. The method may further include steps of disposing the vertical portion of each of the first tube and the second tube into the ground screw and coupling the frame to the ground screw. The method may include a step of coupling the solar panel to the mounting bracket.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a foundation structure according to an embodiment of the present disclosure.

FIG. 2 is a bottom perspective view of the foundation structure shown in FIG. 1.

FIG. 3 is a front elevational view of the foundation structure shown in FIG. 1.

FIG. 4 is a bottom plan view of the foundation structure shown in FIG. 1.

FIG. 5 is a top plan view of the foundation structure shown in FIG. 1.

FIG. 6 is a left-side elevational view of the foundation structure shown in FIG. 1.

FIG. 7 is an exploded view of the foundation structure shown in FIG. 7.

FIG. 8 is an enlarged view of a portion of the foundation structure shown in FIG. 1, particularly illustrating a mounting bracket coupled to a frame, the frame having a cutaway portion to show a connecting tube used in coupling portions of the frame together.

FIG. 9 is an exploded view of a portion of the foundation structure shown in FIG. 1, particularly illustrating the mounting bracket and fasteners.

FIG. 10 is a bottom perspective view of a portion of the foundation structure shown in FIG. 1, particularly illustrating the mounting bracket alone.

FIG. 11 is a top plan view of the mounting bracket shown in FIG. 10.

FIG. 12 is a left side elevational view of the mounting bracket shown in FIG. 10.

FIG. 13 is an enlarged front elevational view of a portion of the foundation structure shown in FIG. 1, particularly illustrating the mounting bracket coupled to a frame without fasteners.

FIG. 14 is another enlarged front elevational view of the portion of the foundation structure shown in FIG. 13, particularly illustrating the mounting bracket coupled to the frame with the connecting tube disposed inside a horizontal portion of each of a first tube and a second tube of the frame.

FIG. 15 is an exploded view of a portion of the foundation structure shown in FIG. 1, particularly illustrating the mounting bracket with the frame and the plurality of fasteners.

FIG. 16 is a schematic block diagram illustrating a foundation structure for a solar panel system, according to an embodiment of the present disclosure.

FIG. 17 is an elevational view of a ground screw coupled to the foundation structure for a solar panel system, according to an embodiment of the present disclosure.

FIG. 18 is perspective view of foundation structure coupled to ground screws, according to an embodiment of the present disclosure.

FIG. 19 is an enlarged view of a portion of the foundation structure shown in FIG. 18, particularly illustrating the connection between the ground screw and the vertical portion of the frame.

FIG. 20 is a cross-sectional perspective view of the foundation structure shown in FIG. 19.

FIG. 21 is a flowchart illustrating a method of installing a solar panel system, according to yet another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

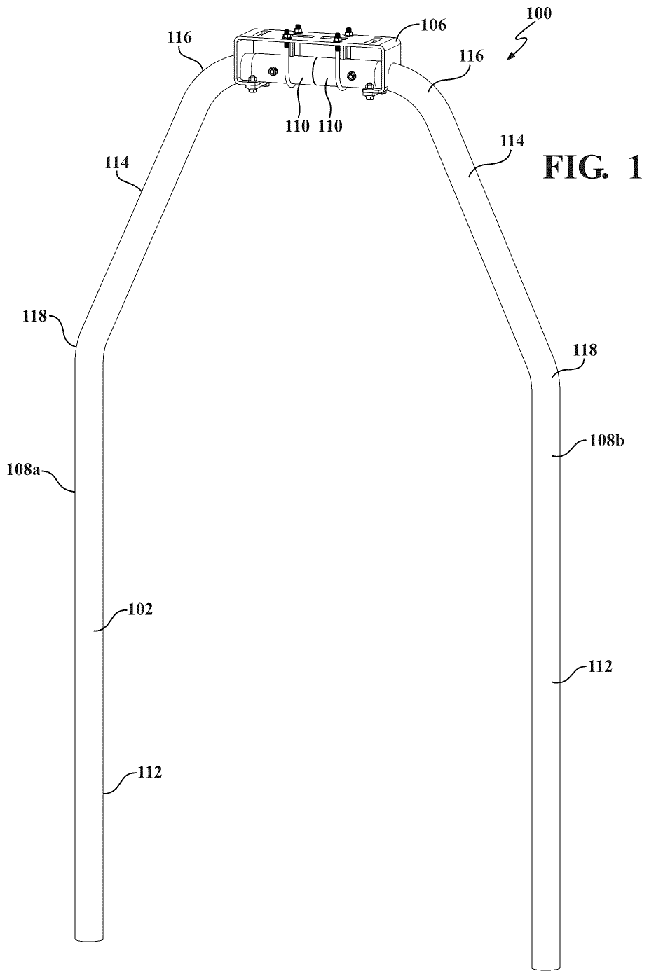

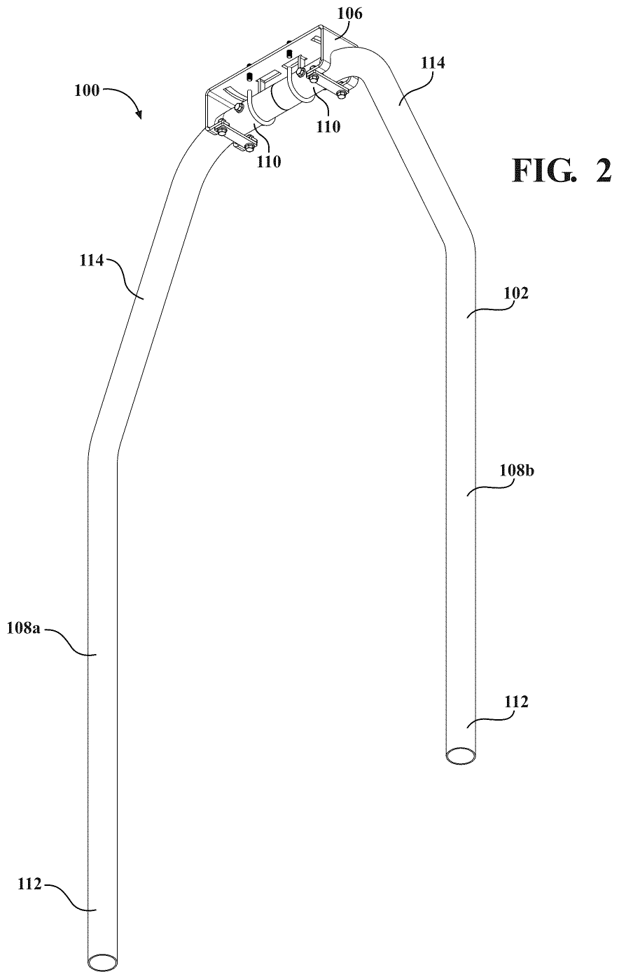

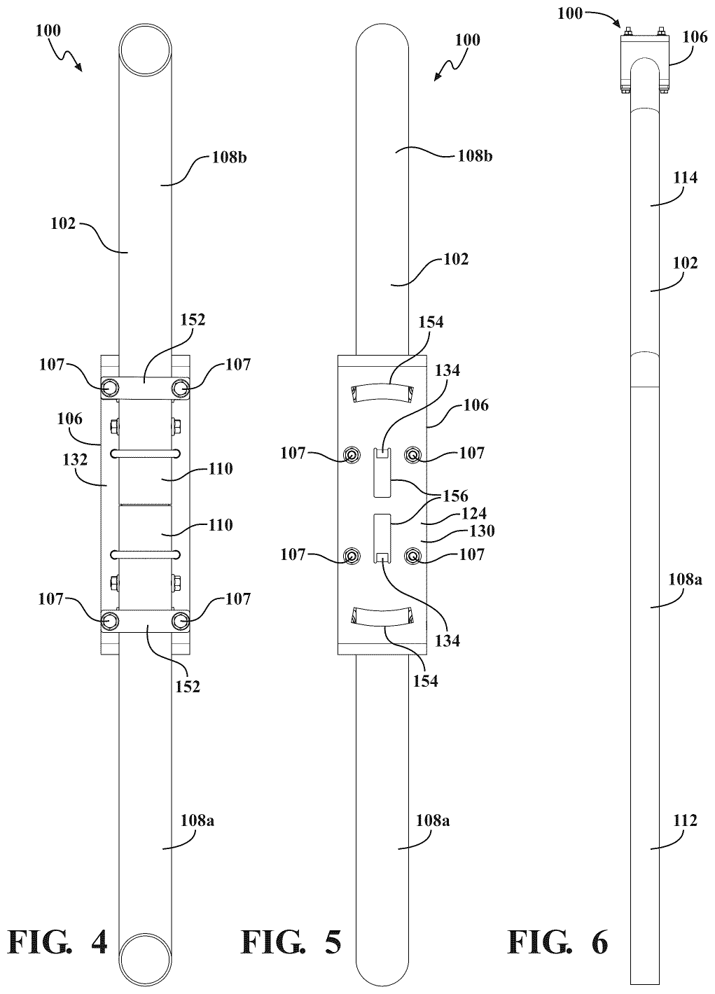

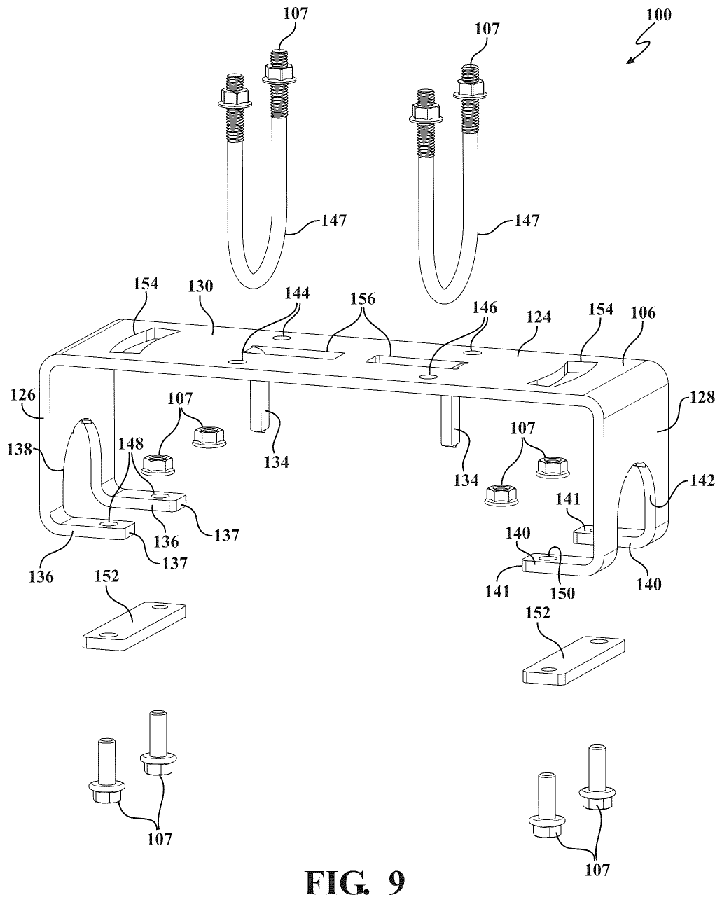

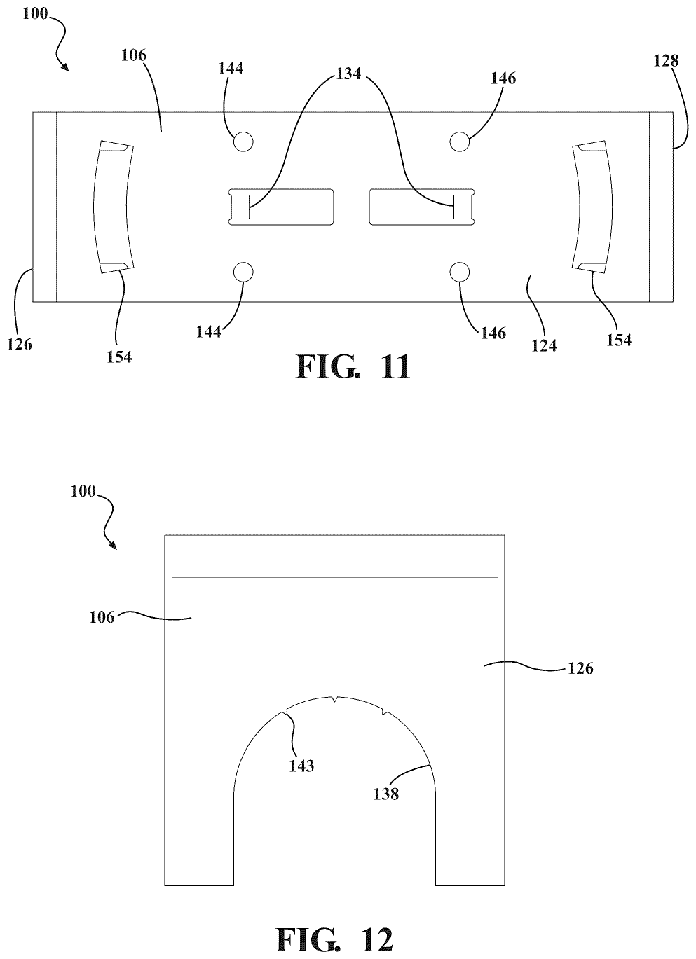

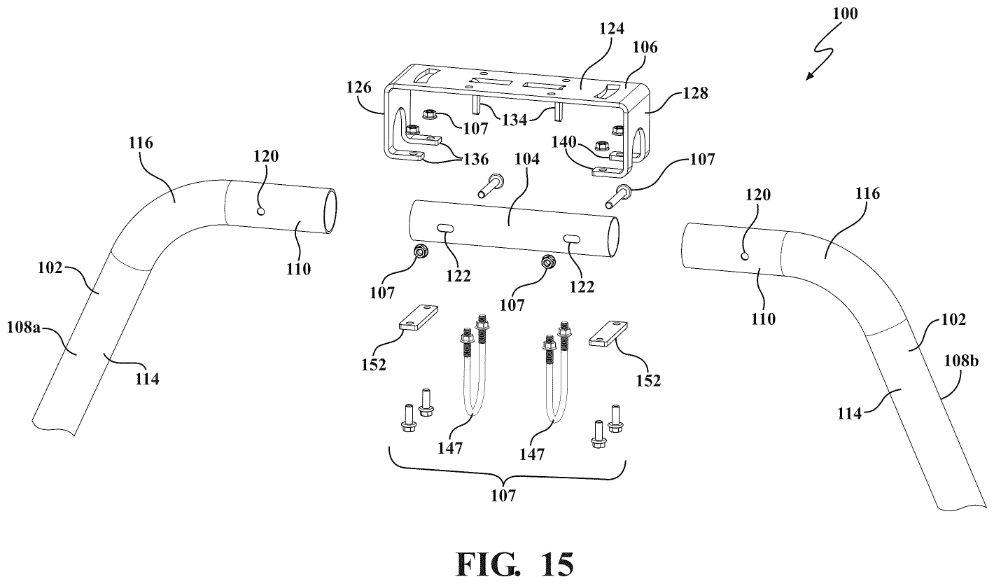

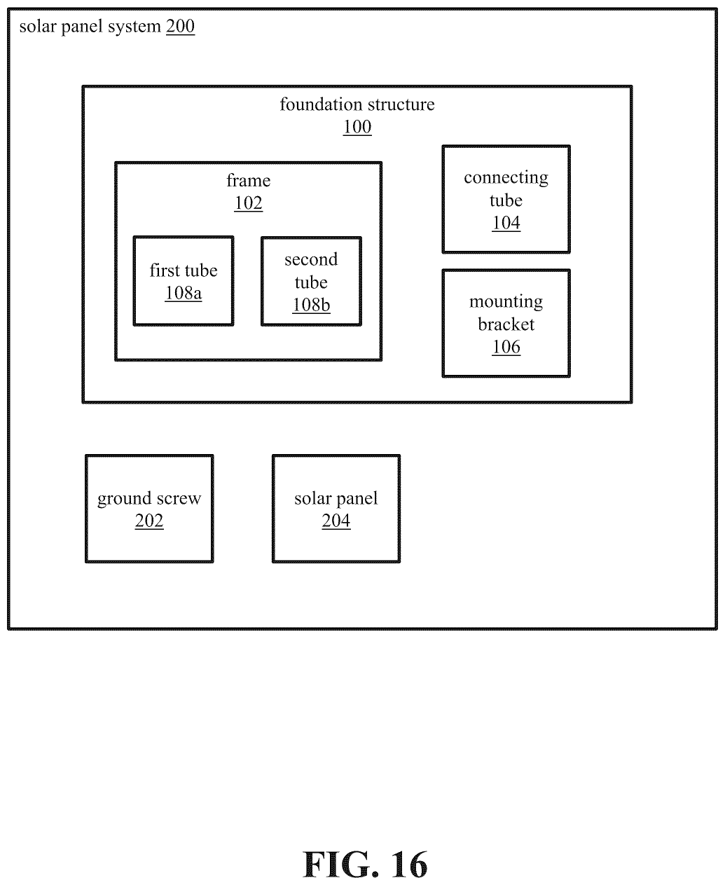

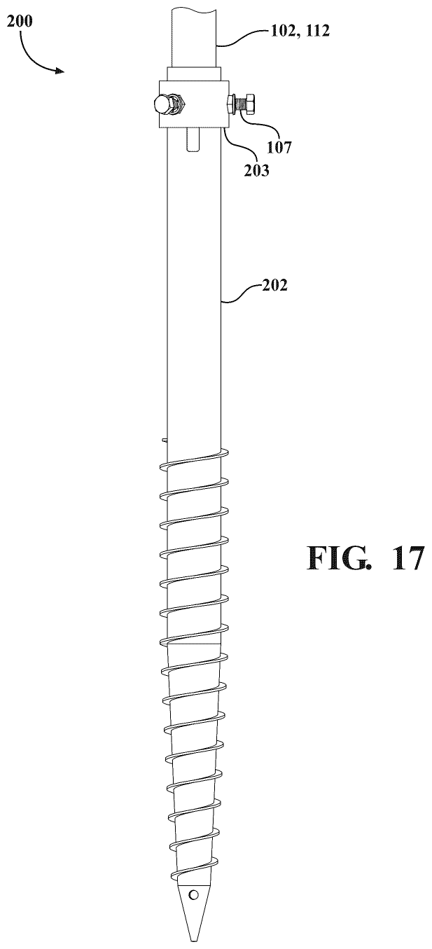

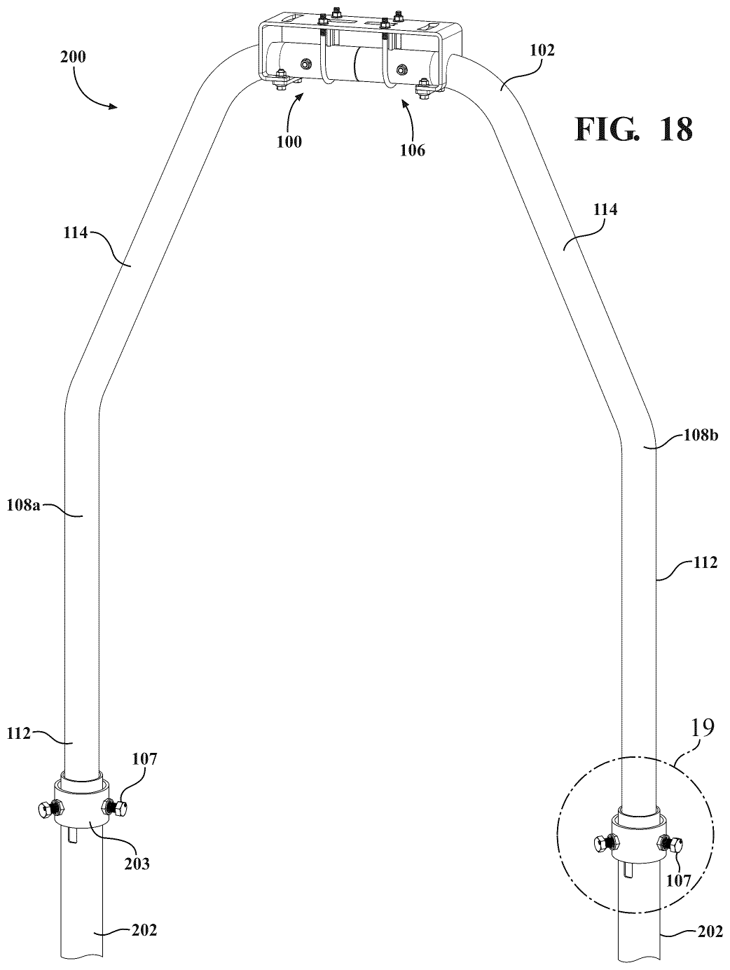

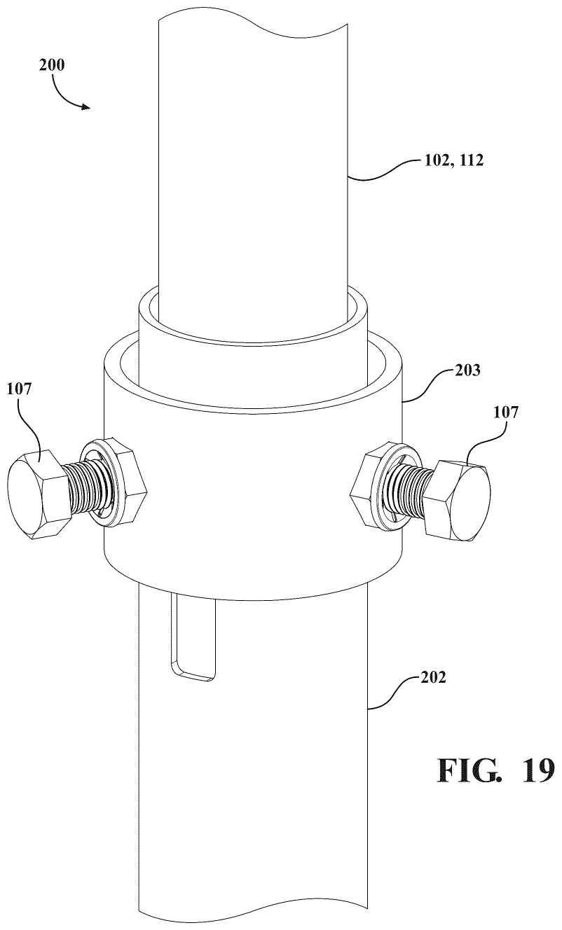

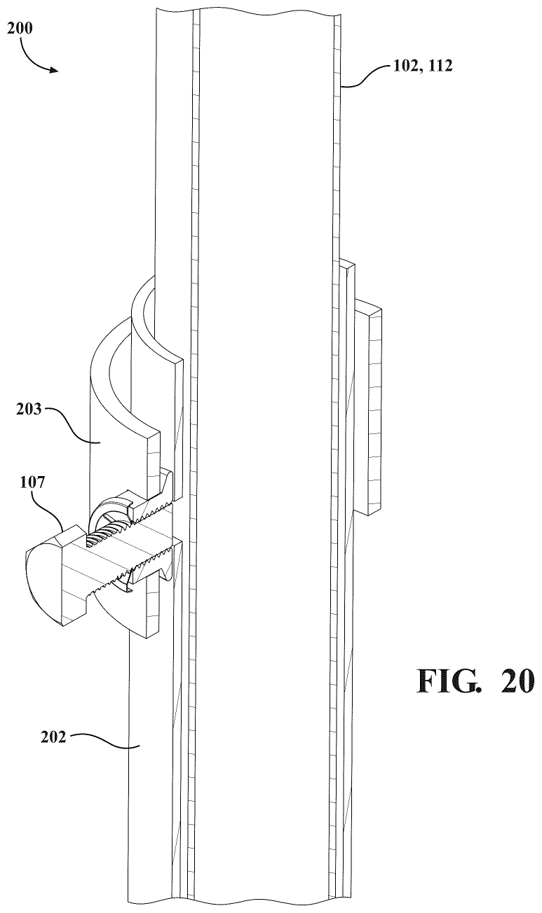

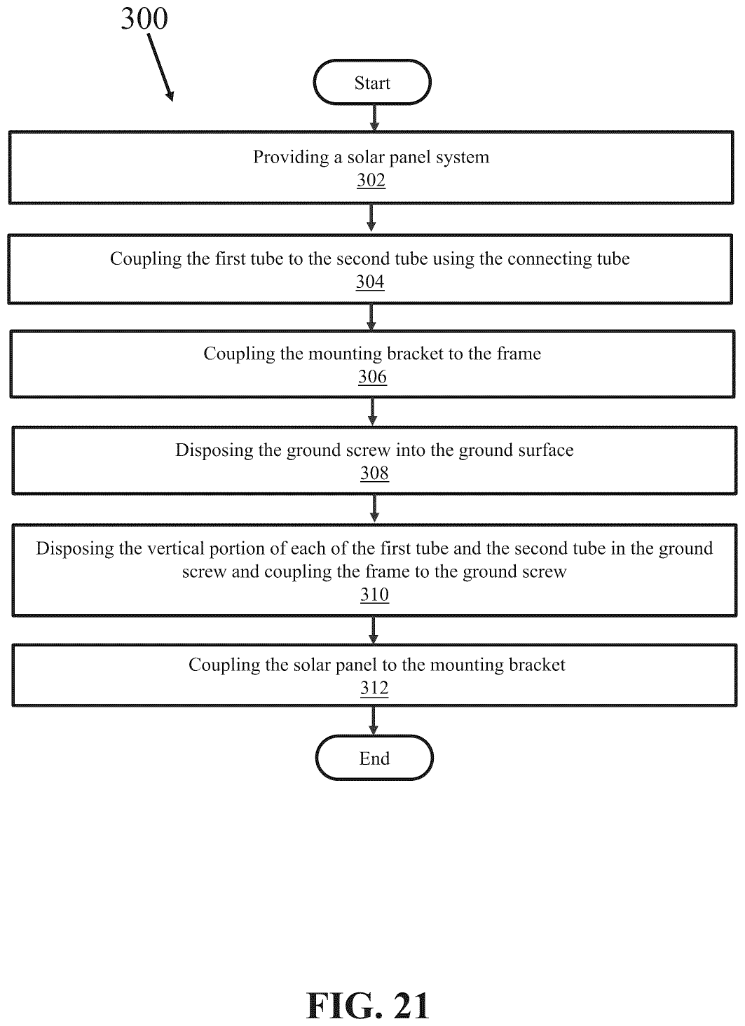

The present technology provides a foundation structure for a solar panel installation. With reference to FIGS. 1-15, a foundation structure 100 may be provided according to an embodiment of the present disclosure. The foundation structure 100 may be configured to provide an enhanced structure capable of supporting a weight of one or more solar panels while maintaining structural integrity of the foundation. With reference to FIGS. 16-20, a solar panel system 200 may also be provided according to another embodiment of the present disclosure. A method 300 of installing the solar panel system 200 may also be provided, as shown in FIG. 21, in another embodiment of the present disclosure.

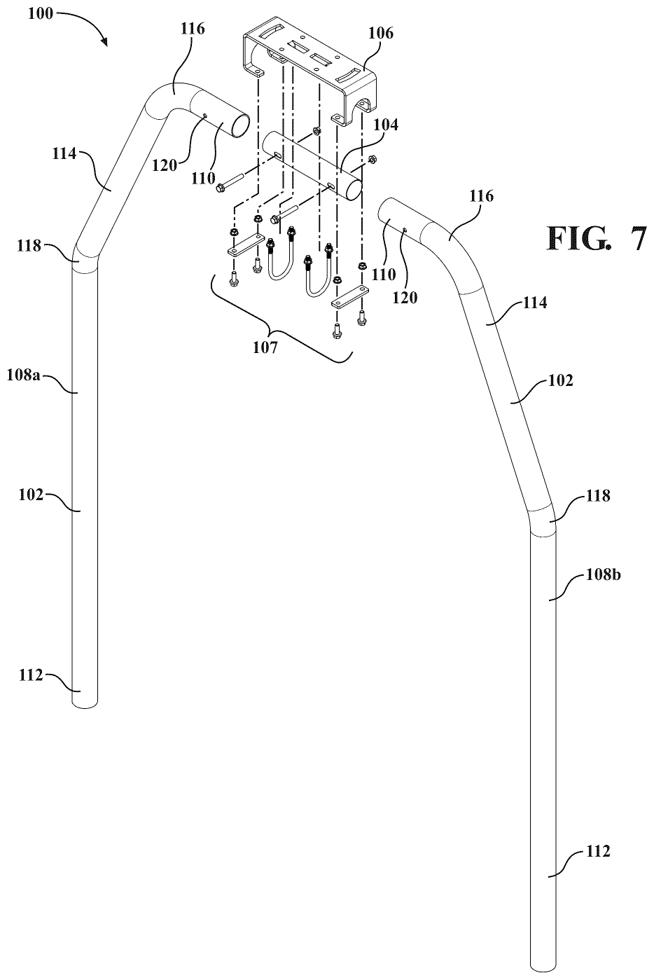

With reference to FIGS. 1-15, the foundation structure 100 may include a frame 102, a connecting tube 104, and a mounting bracket 106. The foundation structure 100 may also include a plurality of fasteners 107. The frame 102 may be configured to form a foundation or base configured to support a solar panel, as described herein, with the connecting tube 104 disposed within the frame 102 and the mounting bracket 106 configured to couple the solar panel to the frame 102. As shown in FIG. 7, the frame 102 may include separate portions that are coupled using the connecting tube 104. Each of the frame 102, the connecting tube 104, and the mounting bracket 106 may be configured to be coupled to one another via the plurality of fasteners 107, as described herein. It should be appreciated that the plurality of fasteners 107 may include any fastener within the scope of the present disclosure configured to fasten one component to another, including a screw, a nut, a bolt, a washer, and other variations thereof. Desirably, this allows for a simplified solar panel installation with a reduction of components needed to form the frame 102 for optimized shipping and transportation of the foundation structure 100 to a desired installation location.

The frame 102 may be defined by a first tube 108a and a second tube 108b, where connecting each of the first tube 108a and the second tube 108b forms the frame 102 that may be substantially A-shaped. The frame 102 may also be substantially triangular in shape, in an alternative embodiment. It should be appreciated that the first tube 108a may be identical to the second tube 108b or may be mirror image to the second tube 108b. Each of the first tube 108a and the second tube 108b may be hollow and may be manufactured from metal tubing. The tubes 108a, 108b may be formed from a single piece of tubing or from two pieces of tubing. One of ordinary skill in the art may select a suitable configuration for the first tube 108a and the second tube 108b within the scope of the present disclosure. Advantageously, forming the frame 102 into two pieces (the first tube 108a and the second tube 108b) allows for minimizing space and packaging requirements during shipping of the foundation structure 100 for enhanced installation.

Each of the first tube 108a and the second tube 108b may include a horizontal portion 110 and a vertical portion 112, which make up the respective tubes 108a, 108b. The horizontal portion 110 may be configured to connect each of the first tube 108a and the second tube 108b to form the frame 102, and specifically form the A-shape of the frame 102. The vertical portion 112 may be configured to connect to a ground screw 202 for the solar panel installation. The horizontal portion 110 may be perpendicular to the vertical portion 112.

The first tube 108a and the second tube 108b may also include an angled portion 114, a first corner 116, and a second corner 118. The angled portion 114 may be disposed between the horizontal portion 110 and the vertical portion 112. The first corner 116 may connect the horizontal portion 110 to the angled portion 114 and the second corner 118 may connect the angled portion 114 to the vertical portion 112. This allows the angled portion 114 to be disposed adjacent to and connected with the horizontal portion 110 and the vertical portion 112. It should be appreciated that the first corner 116 and the second corner 118 may form bends in the first tube 108a and the second tube 108b, respectively, to form the A-shape of the frame 102. More specifically, the angled portion 114, first corner 116, and second corner 118 may position the horizontal portion 110 perpendicular to the vertical portion 112.

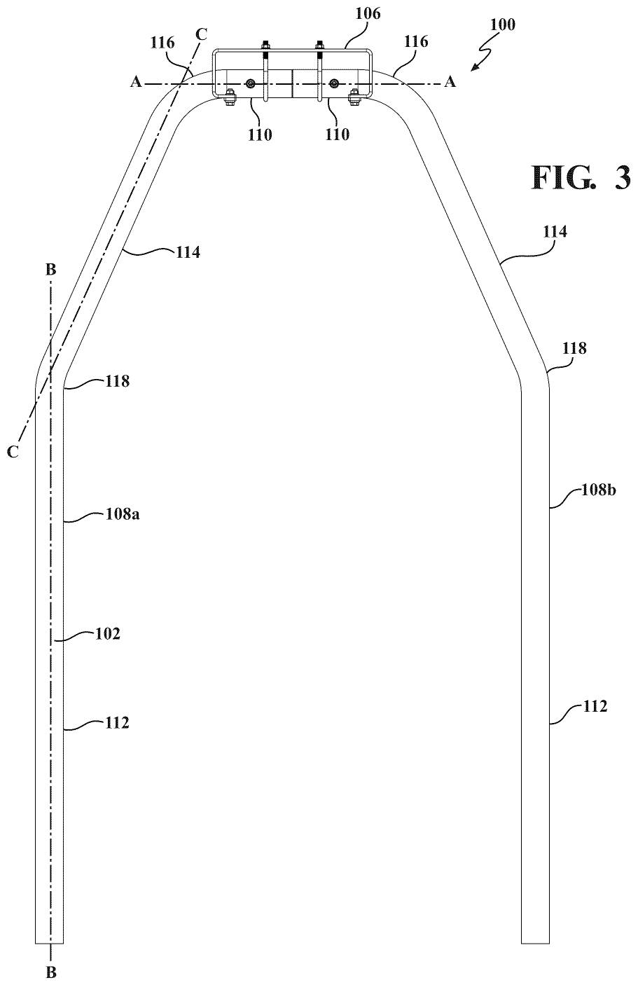

With reference to FIG. 3, the horizontal portion 110 may be disposed on a first axis (A), the vertical portion 112 may be disposed on a second axis (B), and the angled portion 114 may be substantially disposed on a third axis (C). The first axis (A) may be perpendicular to the second axis (B). The third axis (C) may intersect each of the first axis (A) and the second axis (B). Advantageously, forming the frame 102 in two separate tubes, including the first tube 108a and the second tube 108b, militates against the need for multiple brackets and multiple tubes that would require fastening to one another to form the A-shaped frame for solar panel installation. Desirably, each of the horizontal portion 110, the vertical portion 112, and the angled portion 114 of the tubes 108a, 108b may be integral to one another, militating against the need for multiple tubes to create the substantially A-shaped frame.

With continued reference to FIGS. 1-15, the horizontal portion 110 of each of the first tube 108a and the second tube 108b may include a first bore 120 disposed through the horizontal portion 110 extending entirely through the horizontal portion 110 from one side to another side of the horizontal portion 110. The first bore 120 may also be a through-hole, configured to receive a fastener of the plurality of fasteners 107. For example, the fastener may be a screw fastener. The first bore 120 may be substantially circular in shape for receiving the screw fastener.

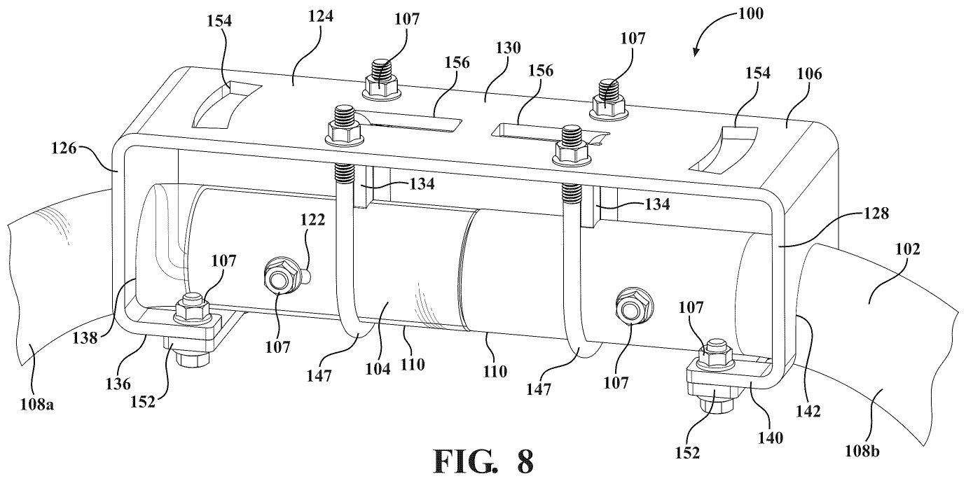

The connecting tube 104 of the foundation structure 100 may also be hollow and configured to be received through the horizontal portion 110 of each of the first tube 108a and the second tube 108b. The connecting tube 104 may be configured as a support tube within the frame 102 to withstand the weight of the solar panel when installed and mounted on the frame 102. More specifically, the connecting tube 104 may similarly include a second bore 122 extending entirely through the connecting tube 104 from one side to another side of the connecting tube 104. The connecting tube 104 may include two bores 122 therethrough for coupling the connecting tube 104 to each of the first tube 108a and the second tube 108b, as shown in FIGS. 7 and 8. The second bore 122 may be substantially oval in shape. The connecting tube 104 may be configured to be disposed within the frame 102, particularly disposed within the horizontal portion 110 of each of the first tube 108a and the second tube 108b. As shown in FIG. 8, an entirety of the connecting tube 104 may be disposed within each of the first tube 108a and the second tube 108b of the frame 102. For example, the horizontal portion 110 of each of the first tube 108a and the second tube 108b may include an inner diameter (D1) and the connecting tube 104 may include an outer diameter (D2). The outer diameter (D2) of the connecting tube 104 may be less than the inner diameter (D1) of the horizontal portion 110 of each of the first tube 108a and the second tube 108b to allow the entirety of the connecting tube 104 to be disposed within the horizontal portion 110. Importantly, disposing the connecting tube 104 within the horizontal portion 110 of each of the tubes 108a, 108b allows the first bore 120 to be aligned with the second bore 122 for receiving one of the fasteners of the plurality of fasteners 107.

The connecting tube 104 may be fastened to the horizontal portion 110 of each of the first tube 108a and the second tube 108b via the fasteners 107, thereby coupling the first tube 108a to the second tube 108v. The fastener may include various fasteners, such as a screw, nut, and bolt. One of ordinary skill in the art may select a suitable fastener to couple and secure the connecting tube 104 within the horizontal portion 110. It should be appreciated that a screw or bolt may be inserted through each of the first bore 120 of the first tube 108a and the first bore 120 of the second tube 108b, as well inserted through the second bore 122 of the connecting tube 104, where a nut may be used to secure the bolt therethrough. Advantageously, the connecting tube 104 may provide structural integrity to the frame 102 during installation when the frame 102 is secured to a ground surface.

Once the connecting tube 104 is secured to the frame 102, the mounting bracket 106 may be coupled to the frame 102 while the connecting tube 104 is disposed entirely inside the horizontal portion 110 of each of the first tube 108a and the second tube 108b. The mounting bracket 106 may have a substantially rectangular shape. More specifically, the mounting bracket 106 may include a top wall 124, a first end wall 126, and a second end wall 128, where each of the top wall 124, the first end wall 126, and the second end wall 128 may be integral to one another forming the mounting bracket 106. The mounting bracket 106 may also include a substantially smooth surface. In a preferred embodiment, the mounting bracket 106 may be formed as a single integral piece. In another embodiment, the mounting bracket 106 may be formed in separate pieces configured to connect to one another or permanently affixed to one another (e.g., welded) to form the substantially rectangular shape. One of ordinary skill in the art may select a suitable configuration for forming the mounting bracket 106 within the scope of the present disclosure. Desirably, the mounting bracket 106 may allow for adjustment post-installation between the frame 102 and the mounting bracket 106 once the solar panel is coupled to the mounting bracket 106.

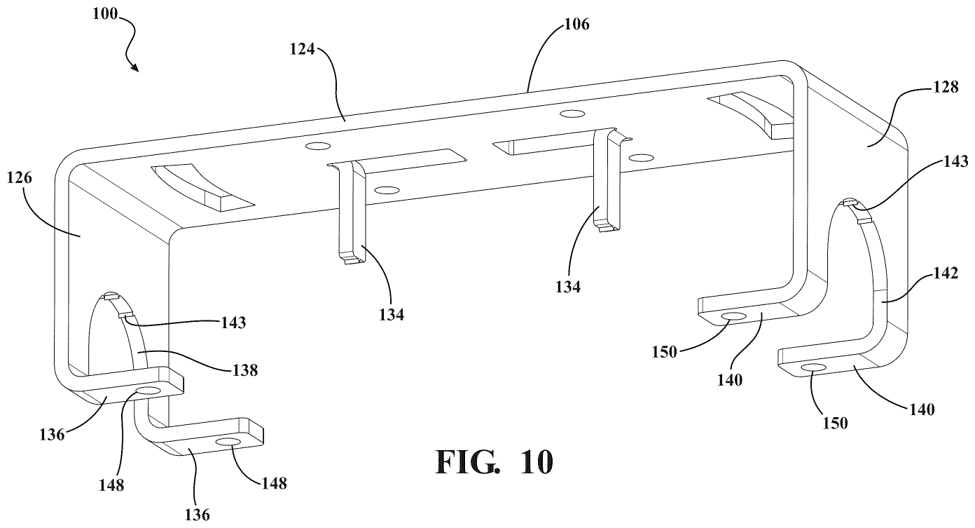

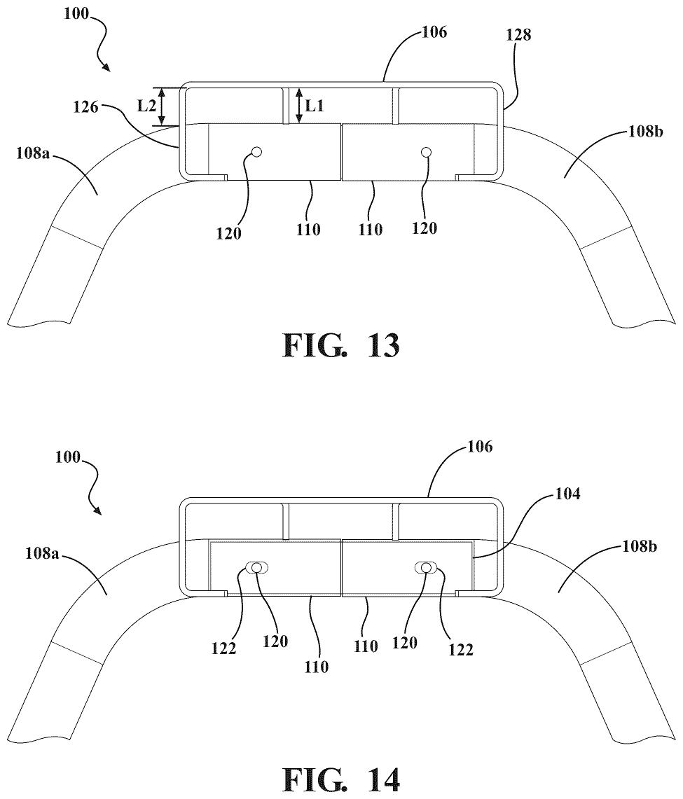

With continued reference to FIGS. 1-15, and particularly to FIGS. 8-11, the top wall 124 of the mounting bracket 106 may include an upper surface 130 and a lower surface 132. The solar panel may be configured to be disposed adjacent the upper surface 130 of the mounting bracket 106 while the lower surface 132 may be disposed adjacent the frame 102 as the mounting bracket 106 is secured to the frame 102. More specifically, the lower surface 132 of the mounting bracket 106 may include a pair of support posts 134 extending outwardly from the upper surface 130 down to the lower surface 132, extending below the lower surface 132 of the top wall 124. The pair of support posts 134 may be configured to abut the horizontal portion 110 of each of the first tube 108a and the second tube 108b when the mounting bracket 106 is secured to the frame 102. The pair of support posts 134 may be configured to enhance the structural integrity of the top wall 124 when the mounting bracket 106 is secured to the frame 102 in a similar configuration to reinforcing posts. Specifically, the pair of support posts 134 may also position the top wall 124 parallel to the horizontal portion 110 of each of the first tube 108a and the second tube 108b, and may separate the top wall 124 from the horizontal portion 110 of each of the tubes 108a, 108b. The pair of support posts 134 may include a curvature as well, as shown in FIG. 10. The pair of support posts 134 may also include a ridge formed on an end of the support posts 134. The ridge may be configured to provide additional grip when the mounting bracket 106 is secured to the first tube 108a and the second tube 108b to militate against slipping. The pair of support posts 134 may include one or more ridges formed thereon. The pair of support posts 134 may include a first length (L1), as shown in FIG. 13.

The first end wall 126 of the mounting bracket 106 may include a first pair of protuberances 136 extending outwardly relative to the first end wall 126. Each of the protuberances 136 may define a hemispherical opening 138 formed between the first pair of protuberances 136 for receiving the first tube 108a of the frame 102. Similarly, the second end wall 128 may include a second pair of protuberances 140 extending outwardly relative to the second end wall 128 where each of the protuberances 140 may also form a hemispherical opening 142 between the second pair of protuberances 140 for receiving the second tube 108b of the frame 102. The first pair of protuberances 136 and the second pair of protuberances 140 may be coplanar to one another. The first pair of protuberances 136 may extend from the first end wall 126 to form an L-shape with the first end wall 126. The second pair of protuberances 140 may extend from the second end wall 128 to form an L-shape as well with the second end wall 128.

The first end wall 126 may include a second length (L2). The second length (L2) may be defined as a length (or distance) from the first end wall 126 to the hemispherical opening 138, as shown in FIG. 13. It should be appreciated that the second end wall 128 may similarly include the second length (L2) as the first end wall 126 is identical to the second end wall 128. This means that the second length (L2) may also be defined as a length from the second end wall 128 to the hemispherical opening 142. The first length (L1) of the pair of support posts 134 may be equal to the second length (L2) of the first end wall 126 and the second end wall 128, respectively, which allows the frame 102 to be positioned within the mounting bracket 106 during installation of the solar panel. This allows the first tube 108a and the second tube 108b to be received within the mounting bracket 106 and specifically allows the first tube 108a to be received within the hemispherical opening 138 and the second tube 108b to be received within the hemispherical opening 142 of the mounting bracket 106, as shown in FIGS. 8 and 14. The hemispherical opening 138, 142 may also include ridges 139, 143, respectively, providing additional grip and support of the horizontal portion 110 of each of the first tube 108a and the second tube 108b when secured within the mounting bracket 106. The ridges 139, 143 may be provided in any shape or size as desired by one of ordinary skill in the art within the scope of the present disclosure.

With reference to FIGS. 8-11, the top wall 124 of the mounting bracket 106 may include a first pair of receiving apertures 144 and a second pair of receiving apertures 146. The first pair of receiving apertures 144 and the second pair of receiving apertures 146 may be configured to receive a fastener 147 of the plurality of fasteners 107. The fastener 147 may be a U-shaped bolt fastener, as shown in FIGS. 8, 9, and 15. The U-shaped bolt fastener 147 may be configured to retain and hold the horizontal portion 110 of each of the first tube 108a and the second tube 108b of the frame 102 to the mounting bracket 106 while securing the mounting bracket 106 from the top wall 124 to the frame 102.

The first pair of receiving apertures 144 and the second pair of receiving apertures 146 may be circular in shape, for example. The receiving apertures 144, 146 may be configured as any shape for receiving a fastener. The first pair of receiving apertures 144 and the second pair of receiving apertures 146 may be disposed adjacent the pair of support posts 134. The first pair of receiving apertures 144 may be disposed adjacent a support post of the pair of support posts 134 while the second pair of receiving apertures 146 may be disposed adjacent the other support post of the pair of support posts 134. More specifically, the one support post of the pair of support posts 134 may be centrally disposed therebetween the first pair of receiving apertures 144, extending from the upper surface 130 to the lower surface 132 of the top wall 124. The other support post of the pair of support posts 134 may be centrally disposed between the second pair of receiving apertures 146, from the upper surface 130 to the lower surface 132 of the top wall 124 as well.

The first pair of protuberances 136 may also include an aperture 148 formed therethrough each protuberance of the first pair of protuberances 136. The second pair of protuberances 140 may also include an aperture 150 formed through each protuberance of the second pair of protuberances 140. The apertures 148, 150 may be disposed adjacent an edge 137, 141 of the protuberances 136, 140, respectively. Each of the apertures 148, 150 may be circular in shape and may be configured to receive a fastener of the plurality of fasteners 107. More specifically, the apertures 148, 150 may be configured to receive the fastener 107 such as a bolt, as well as a cross member 152. The cross member 152 may be disposed beneath the first pair of protuberances 136 and the second pair of protuberances 140, respectively, to secure the frame 102 within the hemispherical opening 138, 142 of the mounting bracket 106, as shown in FIGS. 8 and 14. Advantageously, this allows the frame 102 to pivot up and down (north-south) relative to the mounting bracket 106 and to allow for slip adjustment.

The mounting bracket 106 may also include apertures disposed through the top wall 124 and configured to receive the solar panel during installation. The apertures may include a pair of angled apertures 154 and a pair of rectangular apertures 156. The angled apertures 154 may include a curved cross section while the rectangular apertures 156 may be rectangular in shape. The rectangular apertures 156 may be disposed adjacent the receiving apertures 144, 146 and the pair of support posts 134. The rectangular apertures 156 may be formed with the pair of support posts 134 disposed therebetween. One of ordinary skill in the art may configure each of the angled apertures 154 and the rectangular apertures 156 in the top wall 124 for receiving the solar panel for a solar panel installation in any desired configuration within the scope of the present disclosure.

As shown in FIGS. 16-20, a solar panel system 200 may be provided according to another embodiment of the present disclosure. The solar panel system 200 may include the foundation structure 100, as described herein, a ground screw 202, and a solar panel 204. The ground screw 202 may be configured to be attached to the frame 102 of the foundation structure 100. More specifically, the vertical portion 112 of the first tube 108a and the second tube 108b of the frame 102 may be received through the ground screw 202. One of ordinary skill in the art may select a suitable ground screw 202 or ground anchor for receiving the frame 102 within the scope of the present disclosure. The ground screw 202 may be fastened to the vertical portion 112 of the frame 102 via any suitable fastener assembly. The fastener assembly may include a collar 203 and a fastener of the plurality of fasteners 107 such as a screw fastener. Advantageously, the solar panel system 200 may militate against the need for multiple tubes and separate brackets to connect the frame 102 to the ground screw 202 as the frame 102 may be connected and fastened to the ground screw 202 via the collar 203 and the screw fastener.

The solar panel 204 may be configured to couple to the mounting bracket 106 attached to the frame 102. The solar panel 204 may be directly coupled to the mounting bracket 106. Alternatively, the solar panel 204 may include a base where the base may be coupled to the mounting bracket 106. The solar panel 204 may include an intermediate bracket configured to be coupled to the mounting bracket 106 for providing the solar panel installation. One of ordinary skill in the art may select a suitable solar panel 204 to couple to the mounting bracket 106 of the foundation structure 100 within the scope of the present disclosure to facilitate attaching the solar panel 204 to the mounting bracket 106.

As shown in FIG. 21, a method 300 of installing a solar panel installation may include a step 302 of providing the solar panel system 200 as described herein. The method 300 may include a step 304 of coupling the first tube 108a to the second tube 108b using the connecting tube 104. The method 300 may include a step 306 of coupling the mounting bracket 106 to the frame 102. The method 300 may include a step 308 of disposing the ground screw 202 into the ground surface. The method 300 may include a step 310 of disposing the vertical portion 112 of each of the first tube 108a and the second tube 108b in the ground screw 202 and coupling the frame 102 to the ground screw 202. The method 300 may include a step 312 of coupling the solar panel 204 to the mounting bracket 106.

The foundation structure 100 provides certain benefits and advantages in providing an enhanced structure capable of supporting a weight of a solar panel. The foundation structure 100 provides a simplified solar panel installation with a reduction of components needed to form the frame 102 for optimized shipping and transportation of the foundation structure 100 to a desired installation location. Forming the frame 102 into two pieces (the first tube 108a and the second tube 108b) allows for reduced components during shipping of the foundation structure 100 for enhanced installation. Each of the horizontal portion 110, the vertical portion 112, and the angled portion 114 of the tubes 108a, 108b may be integral to one another, militating against the need for multiple tubes to create the substantially A-shaped frame. The connecting tube 104 may provide structural integrity to the frame 102 during installation when the frame 102 is secured through a ground surface. The mounting bracket 106 may allow for adjustment post-installation between the frame 102 and the mounting bracket 106 once the solar panel is coupled to the mounting bracket 106. The solar panel system 200 may militate against the need for multiple tubes and separate brackets to connect the frame 102 to the ground screw 202 as the frame 102 may be connected and fastened to the ground screw 202 via the collar 203 and the screw fastener.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A foundation structure for supporting a solar panel, comprising:
a frame including a first tube configured to be coupled to a second tube, each of the first tube and the second tube having a horizontal portion and a vertical portion;
a connecting tube configured to be received within the horizontal portion of the first tube and the horizontal portion of the second tube to thereby couple the first tube to the second tube; and
a mounting bracket configured to be secured to the first tube and the second tube, the mounting bracket configured to be coupled to the solar panel, the mounting bracket having a substantially rectangular shape including:
a top wall,
a first end wall having a first pair of protuberances extending outwardly therefrom and defining a hemispherical opening for receiving the first tube of the frame, and
a second end wall having a second pair of protuberances extending outwardly therefrom and defining a hemispherical opening for receiving the second tube of the frame.

2. The foundation structure of claim 1, wherein each of the first tube and the second tube includes an angled portion, a first corner, and a second corner.

3. The foundation structure of claim 2, wherein the first corner connects the horizontal portion to the angled portion, and the second corner connects the angled portion to the vertical portion.

4. The foundation structure of claim 3, wherein the angled portion, the first corner, and the second corner are configured to position the horizontal portion perpendicular to the vertical portion.

5. The foundation structure of claim 1, wherein the horizontal portion of the first tube, the horizontal portion of the second tube, and the connecting tube include bores configured to receive a fastener therethrough when the connecting tube is received within the horizontal portion of the first tube and the horizontal portion of the second tube.

6. The foundation structure of claim 5, wherein an entirety of the connecting tube is disposed within each of the first tube and the second tube when the connecting tube is received within the horizontal portion of the first tube and the horizontal portion of the second tube.

7. The foundation structure of claim 1, wherein the top wall of the mounting bracket includes a pair of support posts extending from a lower surface of the top wall.

8. The foundation structure of claim 7, wherein the pair of support posts is configured to abut the horizontal portion of each of the first tube and the second tube when the mounting bracket is secured to the first tube and the second tube.

9. The foundation structure of claim 8, wherein the pair of support posts includes a first length, and each of the first end wall and the second end wall include a second length defining a distance of the first end wall and the second end wall to the hemispherical opening of the first end wall and the second end wall.

10. The foundation structure of claim 9, wherein the first length is equal to the second length.

11. The foundation structure of claim 10, wherein the top wall of the mounting bracket includes a first pair of apertures and a second pair of apertures, each of the first pair of apertures and the second pair of apertures configured to receive a U-shaped bolt fastener.

12. The foundation structure of claim 11, wherein one support post of the pair of support posts is centrally disposed between the first pair of apertures on the lower surface of the top wall and another support post of the pair of support posts is centrally disposed between the second pair of apertures on the lower surface of the top wall.

13. The foundation structure of claim 12, wherein the pair of support posts is configured to separate the top wall from the horizontal portion of each of the first tube and the second tube.

14. The foundation structure of claim 1, wherein each of the first pair of protuberances and the second pair of protuberances include apertures disposed adjacent edges of the respective protuberances, the apertures configured to receive a fastener to couple a cross member to the respective protuberances.

15. The foundation structure of claim 1, wherein the first pair of protuberances extending from the first end wall and the second pair of protuberances extending from the second end wall form a substantial L-shape.

16. The foundation structure of claim 1, wherein the connecting tube is fastened within each of the horizontal portion of the first tube and the horizontal portion of the second tube via a fastener, the mounting bracket is fastened to each of the horizontal portion of the first tube and the horizontal portion of the second tube via a U-shaped bolt fastener where the first tube is disposed within the hemispherical opening of the first pair of protuberances and the second tube is disposed within the hemispherical opening of the second pair of protuberances, and a cross member is disposed beneath each of the first tube and the second tube.

17. The foundation structure of claim 16, wherein the vertical portion of the first tube and the vertical portion of the second tube is fastened to a ground screw disposed through a ground surface via the fastener.

18. The foundation structure of claim 17, wherein a solar panel is fastened to the mounting bracket via the fastener.

19. A solar panel system, comprising:
a foundation structure for supporting a solar panel, including:
a frame including a first tube configured to be coupled to a second tube, each of the first tube and the second tube having a horizontal portion and a vertical portion,
a connecting tube configured to be received within the horizontal portion of the first tube and the horizontal portion of the second tube to thereby couple the first tube to the second tube, and
a mounting bracket configured to be secured to the first tube and the second tube, the mounting bracket configured to be coupled to the solar panel, the mounting bracket having a substantially rectangular shape including:
a top wall,
a first end wall having a first pair of protuberances extending outwardly therefrom and defining a hemispherical opening for receiving the first tube of the frame, and
a second end wall having a second pair of protuberances extending outwardly therefrom and defining a hemispherical opening for receiving the second tube of the frame;
a ground screw configured to be attached to the vertical portion of the frame and secured in a ground surface; and
a solar panel configured to be coupled to the foundation structure, the solar panel configured to be attached to the mounting bracket of the foundation structure.

20. A method of installing a solar panel, comprising:
providing a solar panel system, including:
a foundation structure for supporting a solar panel, including:
a frame including a first tube configured to be coupled to a second tube, each of the first tube and the second tube having a horizontal portion and a vertical portion,
a connecting tube configured to be received within the horizontal portion of the first tube and the horizontal portion of the second tube to thereby couple the first tube to the second tube, and
a mounting bracket configured to be secured to the first tube and the second tube, the mounting bracket configured to be coupled to the solar panel, the mounting bracket having a substantially rectangular shape including:
a top wall,
a first end wall having a first pair of protuberances extending outwardly therefrom and defining a hemispherical opening for receiving the first tube of the frame, and
a second end wall having a second pair of protuberances extending outwardly therefrom and defining a hemispherical opening for receiving the second tube of the frame,
a ground screw configured to be attached to the vertical portion of the frame and secured in a ground surface, and
a solar panel configured to be coupled to the foundation structure, the solar panel configured to be attached to the mounting bracket of the foundation structure;
coupling the first tube to the second tube using the connecting tube;
coupling the mounting bracket to the frame;
disposing the ground screw into the ground surface;
disposing the vertical portion of each of the first tube and the second tube in the ground screw and coupling the frame to the ground screw; and
coupling the solar panel to the mounting bracket.
